(19) United States
(12) Patent Application Publication
(10) Pub. No.: US 2024/0145685 A1
(43) Pub. Date: May 2, 2024

(54) ELECTRODE SHEET AND ELECTROCHEMICAL DEVICE

(71) Applicant: Zhuhai CosMX Battery Co., Ltd., Zhuhai (CN)

(72) Inventors: Fan YANG, Zhuhai (CN); Yanyun ZHAI, Zhuhai (CN); Jian ZHANG, Zhuhai (CN); Kongyan XIE, Zhuhai (CN); Fen LIU, Zhuhai (CN); Jinshuai YANG, Zhuhai (CN); Chong PENG, Zhuhai (CN)

(21) Appl. No.: 18/399,235

(22) Filed: Dec. 28, 2023

Related U.S. Application Data
(63) Continuation of application No. PCT/CN2022/130116, filed on Nov. 4, 2022.

(30) Foreign Application Priority Data
Nov. 25, 2021 (CN) 2021114109809

(51) Int. Cl. H01M 4/36; H01M 4/131; H01M 4/136; H01M 4/62; H01M 10/42

(52) U.S. Cl. CPC H01M 4/366; H01M 4/131; H01M 4/136; H01M 4/623; H01M 4/625; H01M 10/4235; H01M 2004/021

(57) ABSTRACT

This application provides an electrode sheet and an electrochemical device. The electrode sheet includes a current collector and a functional coating located on at least one surface of the current collector. The functional coating includes a first coating, a second coating and an active material layer that are sequentially stacked on a surface of the current collector. The first coating includes a conductive agent, a binder and a first functional filler, and the second coating includes a conductive agent, a binder and a second functional filler. A mass ratio of the binder in the first coating to the first coating is a1, a mass ratio of the binder in the second coating to the second coating is a2, and a mass ratio of the binder in the active material layer to the active material layer is a3, and a1>a2>a3.

### CROSS-REFERENCE TO RELATED APPLICATIONS

This application is a continuation of International Application No. PCT/CN2022/130116, filed on Nov. 4, 2022, which claims the priority to the Chinese patent application No. 2021114109809, entitled “ELECTRODE SHEET AND ELECTROCHEMICAL DEVICE” and filed on Nov. 25, 2021. Both of the aforementioned applications are hereby incorporated by reference in their entireties.

### TECHNICAL FIELD

This application relates to an electrode sheet and an electrochemical device, belonging to a field of an electrochemical energy storage device.

### BACKGROUND

At present, the electrochemical device such as a lithium-ion battery has been widely used in consumer electronics, travel tools, energy storage, etc. Among them, the lithium-ion battery has the advantages of high energy density, fast charge-and-discharge speed, and long service life, and has gradually become a research focus nowadays. However, in recent years, the electrochemical device such as the lithium-ion battery has been frequently exposed to have problems, such as causing fire and failure, which brings certain potential safety hazards. Generally, the electrochemical device includes a positive electrode sheet, a negative electrode sheet and a separator that separates the positive electrode sheet and the negative electrode sheet. Among them, a short circuit caused by a contact between the positive electrode sheet and the negative electrode sheet, for example, a short circuit caused by a contact between a positive current collector of the positive electrode sheet and the negative electrode sheet, is an important factor that leads to fire and explosion, resulting in a large heat-generating power and less heat dissipation, thereby making it prone to the phenomena such as firing and burning.

At present, main means to improve the safety of the electrochemical device include introducing an active material layer with poor conductivity into the positive electrode sheet, using a composite current collector supplemented with a polymer layer, etc. However, the current solutions will affect performance of the electrochemical device such as cycling performance. A bonding force between the active material layer and the current collector is weak, leading to a limited improvement result on the safety of the electrochemical device. Therefore, how to improve the safety of the electrochemical device while ensuring or even improving the cycling performance thereof is still an urgent technical problem to be solved by those skilled in the art.

### SUMMARY

This application provides an electrode sheet and an electrochemical device, which can simultaneously improve safety and cycling performance of the electrochemical device and other property, and effectively overcome defects of existing technologies.

One aspect of this application provides an electrode sheet, including a current collector and a functional coating located on at least one surface of the current collector. The functional coating includes a first coating located on a surface of the current collector, a second coating located on a surface of the first coating, and an active material layer located on a surface of the second coating. The first coating includes a conductive agent, a binder and a first functional filler, the second coating includes a conductive agent, a binder and a second functional filler, and the active material layer includes a conductive agent, a binder and a first electrode active material. A mass ratio of the binder in the first coating to the first coating is a1, a mass ratio of the binder in the second coating to the second coating is a2, and a mass ratio of the binder in the active material layer to the active material layer is a3, a1>a2>a3.

According to an embodiment of this application, the first functional filler includes an inorganic filler and/or a polymer filler. The inorganic filler includes at least one of alumina (Al₂O₃), silica (SiO₂), silicon monoxide (SiO), titanium oxide (TiO₂), zinc oxide (ZnO₂), zirconium oxide (CrO₂), cerium oxide (CeO₂), vanadium pentoxide (V₂O₅), ferrous oxide (FeO), boehmite (γ-A100H), hydrotalcite, and metal salts; the polymer filler includes at least one of polytetrafluoroethylene particles, polyethylene microspheres, polystyrene microspheres, and polyurethane microspheres; and/or, an average particle size of the first functional filler is D50₁, an average particle size of the second functional filler is D50₂, and an average particle size of the first electrode active material in the active material layer is D50₃, which satisfies D50₁<D50₂<D50₃; and/or, D50₁≤2.5 μm; and/or, D50₂≤3.5 μm; and/or, D50₃>5 μm.

According to an embodiment of this application, an average particle size of the conductive agent in the first coating is D50₄, and D50₄≤0.8μm.

According to an embodiment of this application, the second functional filler includes a second electrode active material and a non-electrode active material. In the second coating, the second electrode active material has a mass content of 0-98.5%, the non-electrode active material has a mass content of 0-98.5%; and the mass content of the second electrode active material and the mass content of the non-electrode active material are not both 0 at the same time; and/or, the second functional filler has a sphericity of P2, and an average particle size of the second functional filler is D50₂ expressed in μm, which satisfies: P₂/D50₂≥0.2, and/or, P₂≥0.70.

According to an embodiment of this application, a mass ratio of the first electrode active material in the active material layer to the active material layer is not less than a mass ratio of the second electrode active material in the second coating to the second coating; and/or, the first electrode active material is the same as or different from the second electrode active material; and/or, the non-electrode active material includes an inorganic filler and/or a polymer filler, the inorganic filler includes at least one of alumina, silica, silicon monooxide, titanium oxide, zinc oxide, zirconium oxide, cerium oxide, vanadium pentoxide, oxide iron, boehmite, hydrotalcite, and metal salt, the metal salt includes barium sulfate and/or calcium sulfate, and the polymer filler includes at least one of polytetrafluoroethylene particles, polyethylene microspheres, polystyrene microspheres and polyurethane microspheres; and/or, in the second coating, neither the mass content of the second electrode active material nor the mass content of the non-electrode active material is 0.

According to an embodiment of this application, the first coating further includes a dispersant. The dispersant includes at least one of sodium carboxymethylcellulose, lithium carboxymethylcellulose, sodium polyacrylate, and polyvinylpyrrolidone. In the first coating, the conductive agent has a mass content of 2%-45%, the binder has a mass content of 5%-70%, the first functional filler has a mass content of 0-70%, and the dispersant has a mass content of 0-10%; and/or, in the second coating, the conductive agent has a mass content of 0.5%-10%, the binder has a mass content of 3%-30%, and the remainder is the second functional filler; and/or, in the active material layer, the conductive agent has a mass content of 0.5%-5%, the binder has a mass content of 1%-5%, and the first electrode active material has a mass content of 90%-98.5%.

According to an embodiment of this application, a thickness of the first coating is not more than a thickness of the second coating, and the thickness of the second coating is less than a thickness of the active material layer; and/or, the thickness of the first coating is 0.5 μm-5 μm, and/or, the thickness of the second coating is 1.5 μm-8 μm, and/or, the thickness of the active material layer is 15 μm-80 μm.

According to an embodiment of this application, the electrode sheet is a positive electrode sheet, and the first electrode active material includes at least one of lithium cobalt oxide, lithium iron phosphate, lithium manganese phosphate, lithium iron manganese phosphate, lithium nickelate, lithium nickel cobalt manganate, lithium nickel cobalt aluminate, lithium vanadium phosphate, lithium-rich manganese material, lithium nickel iron aluminate and lithium titanate.

According to an embodiment of this application, the electrode sheet is a negative electrode sheet, and the first electrode active material includes at least one of artificial graphite, natural graphite, composite graphite, hard carbon, soft carbon, mesocarbon microsphere, petroleum coke, oily needle coke, silicon, silicon oxide, silicon carbon, lithium titanate, and metallic lithium.

According to an embodiment of this application, the electrode sheet is a positive electrode sheet, and the second electrode active material includes at least one of lithium cobalt oxide, lithium iron phosphate, lithium manganese phosphate, lithium iron manganese phosphate, lithium nickelate, lithium nickel cobalt manganate, lithium nickel cobalt aluminate, and lithium vanadium phosphate, lithium-rich manganese material, lithium nickel iron aluminate and lithium titanate.

According to an embodiment of this application, the electrode sheet is a negative electrode sheet, and the second electrode active material includes at least one of artificial graphite, natural graphite, composite graphite, hard carbon, soft carbon, mesocarbon microsphere, petroleum coke, oily needle coke, silicon, silicon oxide, silicon carbon, lithium titanate, and metallic lithium.

Another aspect of this application provides an electrochemical device including the above-mentioned electrode sheet.

In this application, the first coating, the second coating and the active material layer, each having a specific composition, are sequentially stacked on the surface of the current collector, with controlling a1>a2>a3. On the one hand, an adhesion between respective coatings can be ensured and peeling of the coatings can be prevented. On the other hand, the first coating has a highest binder content, which can improve an adhesion between the functional coating and the current collector, thereby preventing the current collector from being exposed in the events of needle puncture, heavy impacts, etc., and avoiding a short circuit caused by a contact between the electrode sheet and an electrode sheet with the other polarity (that is, preventing the short circuit caused by the contact between the positive electrode sheet and the negative electrode sheet). Meanwhile, the first coating is provided on the surface of the current collector and close to the current collector, and is more sensitive to a temperature increase. When the temperature rises due to abnormal overcharging, short circuit, etc., the binder therein will produce a positive temperature coefficient effect (PTC effect) as a PTC component, which causes a quick increase of resistance or even insulation of the first coating, prevents side reactions during overcharging and other processes, and disconnects the circuit in time, thereby preventing the occurrence of fire, explosion and other phenomena. Meanwhile, the conductive agent in the first coating can collect microcurrent transmitted by the second coating and the active material layer, reducing a resistance of the electrode sheet. Therefore, the application can improve the safety of the electrode sheet and the electrochemical device, in particular, it can reduce the safety risk caused by overcharging, needle puncture, heavy impact and other phenomena of an electric core. Meanwhile, it can also reduce the internal resistance, improve the electrical conductivity and energy density, and thus can also take into account the improvement of the cycling performance, rate capability and safety of the electrode sheet and the electrochemical device, which is of great significance for practical industrialization and application.

### BRIEF DESCRIPTION OF DRAWINGS

FIG. 1 is a schematic structural diagram of an electrode sheet in an embodiment of this application.

Explanation of reference signs: 1: first coating; 2: second coating; 3: active material layer; 4: tab; 5: current collector.

### DESCRIPTION OF EMBODIMENTS

In order to enable those skilled in the art to better understand the solution of this application, this application will be further described in detail below. The specific embodiments listed below only describe the principles and features of this application, and the embodiments listed are only used to explain this application and do not limit the scope of this application. Based on the embodiments of this application, all other embodiments obtained by those skilled in the art without creative efforts fall within the protection scope of this application. In the description of this application, unless otherwise explicitly specified and defined, the terms “first”, “second”, etc. are only used for descriptive purposes, for example, distinguishing the composition of each coating, to more clearly illustrate/explain the technical solution. It cannot be understood as indicating or implying the quantity or substantive order of the technical features indicated.

In this application, the average particle size of material A (such as D50₁, D50₂, D50₃, D50₄) may be measured as follows: a Dv50 of the material A is measured using a laser particle size analyzer before preparing the electrode sheet. The Dv50 means a particle size when a volume of the materials accumulates to 50% from small-particle-size side in a distribution of the particle size based on the volume. The Dv50 is the average particle size of the above-mentioned material A. Alternatively, a coating sample is taken out from the electrode sheet after the electrode sheet is prepared, and the average particle size of the material A in the taken sample is measured by a Focused Ion Beam (FIB) Microscopy.

The electrode sheet of this application includes a current collector 5 and a functional coating located on at least one surface of the current collector 5. The functional coating includes a first coating 1 located on the surface of the current collector 5, a second coating 2 located on the surface of the first coating 1 and an active material layer 3 located on the surface of the second coating 2. The first coating 1 includes a conductive agent, a binder and a first functional filler, the second coating 2 includes a conductive agent, a binder and a second functional filler, and the active material layer 3 includes a conductive agent, a binder and a first electrode active material. A mass ratio of the binder in the first coating 1 to the first coating 1 (that is, a mass content of the binder in the first coating 1) is a1, a mass ratio of the binder in the second coating 2 to the second coating 2 (that is, a mass content of the binder in the second coating 2) is a2, and a mass ratio of the binder in the active material layer 3 to the active material layer 3 (that is, the mass content of the binder in the active material layer 3) is a3, a1>a2>a3.

In this application, the first coating 1, the second coating 2, and the active material layer 3 are sequentially stacked on the surface of the current collector 5. The first coating 1 is closest to the surface of the current collector 5, which is capable of improving an adhesive force between the overall functional coating and the surface of the current collector 5. The second coating 2 is located between the first coating 1 and the active material layer 3 as a transition layer, and the active material layer 3 is located on the outermost layer of the electrode sheet as a main functional layer for electrode functioning. The conductive agent in each coating is configured to provide an electron channel between respective coatings. For example, the conductive agent in the first coating 1 is configured to provide an electron channel between the current collector 5 and the second coating 2 to ensure conductivity of the electrode sheet. The binder is configured to bond the filler, active materials, conductive agent and other components in each coating, and to bond the coatings to each other and to bond the entire functional coating firmly to the surface of the current collector 5. In a possible implementation, the conductive agents in the first coating 1, the second coating 2, and the active material layer 3 may each include at least one of carbon black, carbon tube, acetylene black, Ketjen black, silver powder, aluminum powder, graphene, and vapor growth carbon fiber. The conductive agents in the first coating 1, the second coating 2, and the active material layer 3 may be the same or different. The binders in the first coating 1, the second coating 2, and the active material layer 3 may each include at least one of polyvinylidene fluoride (PVDF), polyamide, polyacrylic acid, polyacrylonitrile, sodium polymethylcellulose, rubber, polyurethane, polyvinyl acetate, epoxy resin, polyimide, phenolic resin, acrylate, polyisobutylene, polyvinyl ether, polybutadiene, polyisobutylene, cyanate, starch, bismaleimide, polyphenylene propylene, isooctyl acrylate, butyl acrylate, methyl methacrylate and hydroxypropyl methacrylate, in which the rubber may be natural rubber and/or artificial rubber, such as styrene-butadiene rubber (SBR). The binders in the first coating 1, the second coating 2 and the active material layer 3 can be the same or different.

In some embodiments, the first coating 1 further includes a dispersant. In the first coating 1, the conductive agent has a mass content of 2% to 45%, such as 2%, 5%, 10%, 15%, 20%, 25%, 30%, 35%, 40%, 45% or a range composed of any two of them; the binder has a mass content of 5% to 70%, such as 5%, 10%, 20%, 30%, 40%, 50%, 60%, 70% or a range composed of any two of them; the first functional filler has a mass content of 0-70%, such as 0, 1%, 5%, 10%, 20%, 30%, 40%, 50%, 60%, 70% or a range composed of any two of them; and the dispersant has a mass content of 0-10%, such as 0, 1%, 3%, 5%, 7%, 10% or a range composed of any two of them. The first functional filler may include an inorganic filler and/or a polymer filler. The inorganic filler may include at least one of metal oxide, non-metal oxide, hydroxide, etc. Preferably, the inorganic filler includes at least one of alumina, silica, silicon monooxide, titanium oxide, zinc oxide, zirconium oxide, cerium oxide, vanadium pentoxide, ferrous oxide, boehmite, hydrotalcite, and metal salt, in which the metal salt generally includes insoluble salts that are difficult to dissolve in water, for example, barium sulfate and/or calcium sulfate, etc. The polymer filler includes at least one of polytetrafluoroethylene particles, polyethylene microspheres, polystyrene microspheres, and polyurethane microspheres. The dispersant includes at least one of sodium carboxymethylcellulose (CMC-Na), lithium carboxymethylcellulose (CMC-Li), sodium polyacrylate, and polyvinylpyrrolidone.

Relatively speaking, the first functional filler is introduced into the first coating 1 (the mass content of the first functional filler is greater than 0, such as 1% to 70%), which will be beneficial to further enhancing the safety performance of the electrode sheet and battery, and reducing safe risk that may be caused when the battery is overcharged, needle punctured and impacted by a heavy object. Meanwhile, properties of the electrode sheet, such as strength, can also be improved. Introducing the dispersant into the first coating 1 (the mass content of the dispersant is greater than 0, such as 1%-10%) is conducive to dispersing the first functional filler, the conductive agent and other components in the first coating 1 more uniformly, which is not only beneficial to the production of the electrode sheet, but also conducive to further optimizing the performance of the electrode sheet.

In some preferred embodiments, the binder includes polyvinylidene fluoride and the first functional filler includes polytetrafluoroethylene particles in the first coating 1. Since the surface energy of the polytetrafluoroethylene is extremely low, when the temperature rises rapidly due to overcharging of the electrode sheet, etc., the binder and conductive agent attached to the electrode sheet may be gradually peeled off, thereby destroying the conductive network of the electrode sheet, increasing an ohmic polarization of the electrode sheet, inhibiting overcharging and resulting security risks.

In some embodiments, the average particle size of the conductive agent in the first coating 1 is D50₄, where D50₄ is equal to or less than 0.8 μm, which is beneficial to further optimizing the cycling performance and other performances of the electrode sheet. In a possible implementation, the average particle size of the conductive agent in the second coating 2 is D50₅, where D50₅ is equal to or less than 0.8 μm. The average particle size of the conductive agent in the active material layer 3 is D50₆, where D50₆ is equal to or less than 0.8 μm. The conductive agent in the second coating 2, the conductive agent in the active material layer 3 and the conductive agent in the first coating 1 may be the same or different in the average particle size, which is not particularly limited in this application.

In this application, the second functional filler may generally include a second electrode active material and a non-electrode active material. In the second coating 2, the second electrode active material has a mass content of 0-98.5%, and the non-electrode active material has a mass content of 0-98.5%. The mass content of the second electrode active material and the mass content of the non-electrode active material are not both 0 at the same time. The non-electrode active material in the second functional filler means a material that does not participate in the electrochemical reaction of the electrode sheet or the electrochemical device. For example, when the above-mentioned electrode sheet is a positive electrode sheet, the above-mentioned electrode active materials (the first electrode active material and the second electrode active material) are lithium-containing active materials available for lithium extraction and insertion. The non-electrode active material is a lithium-free material, which does not participate in the electrochemical reaction process during the cycle of the electrode sheet, such as lithium extraction and insertion. Specifically, the non-electrode active material may include an inorganic filler and/or a polymer filler. The inorganic filler includes at least one of alumina, silica, silicon monooxide, titanium oxide, zinc oxide, zirconium oxide, cerium oxide, vanadium pentoxide, iron oxide, boehmite, hydrotalcite, and metal salt; and the polymer filler includes at least one of polytetrafluoroethylene particles, polyethylene microspheres, polystyrene microspheres, and polyurethane microspheres. The first electrode active material and the second electrode active material may be the same or different.

Generally, a mass ratio of the first electrode active material in the active material layer 3 to the active material layer 3 (that is, the mass content of the first electrode active material in the active material layer 3) is not less than a mass ratio of the second electrode active material in the second coating 2 to the second coating 2 (that is, the mass content of the second electrode active material in the second coating 2). Preferably, the mass content of the first electrode active material in the active material layer 3 is greater than the mass content of the second electrode active material in the coating 2. In the structure system of the electrode sheet in this application, the second coating 2 plays a transitional role. Adding a second electrode active material to the second coating 2 can provide part of the capacity, ensure the energy density of the electrode sheet, and at the same time control the mass content of the second electrode active material in the second coating 2 to be less than the mass content of the first electrode active material in the active material layer, so that the conductivity of a functional powder for electrode added in the second coating is lower than that of a functional powder for electrode added in the active material layer. The impedance between the electrode sheet and an electrode sheet with the other polarity (that is, between the positive electrode sheet and the negative electrode sheet) may be increased when needle puncture, heavy object impact, etc. occurs, further ensuring safety and other performance of the electrochemical device. In some specific embodiments, the difference between the mass content of the first electrode active material in the active material layer 3 and the mass content of the second electrode active material in the second coating 2 is 10% to 60% for example, such as 10%, 20%, 30%, 40%, 50%, 60% or a range composed of any two of them.

In some embodiments, in the second coating 2, the conductive agent has a mass content of 0.5%-10%, the binder has a mass content of 3%-30%, and a balance of the second coating 2 is the second functional filler (that is, the second functional filler has a mass content of 60% to 96.5%), that is, the sum of the mass contents of the second electrode active material and the non-electrode active material in the second coating 2 is from 60% to 96.5%. Preferably, in the second coating 2, the mass content of the second electrode active material and the mass content of the non-electrode active material are each not 0, that is, the second coating 2 includes both the second electrode active material and the non-electrode active material at the same time. In addition, the mass content of the second electrode active material can be higher than the mass content of the non-electrode active material in the second coating 2. For example, the mass content of the second electrode active material in the second coating 2 is, for example, 30%, 35%, 40%, 45%, 60%, 65%, 70%, 75%, 80% or in a range composed of any two of them; the mass content of the non-electrode active material in the second coating 2 can be 5%, 10%, 15%, 20%, 25%, 28% or in a range composed of any two of them.

In some embodiments, in the active material layer 3, the conductive agent has a mass content of 0.5%-5%, the binder has a mass content of 1%-5%, and the first electrode active material has a mass content of 90%-98.5%.

In this application, the first functional filler is granular and is dispersed in the first coating 1. In some embodiments, the average particle size of the first functional filler is D50₁, and D50₁ is equal to or less than 2.5 μm. In particular, the first functional filler may be nano-sized particles with D50₁≤1μm.

In this application, the second functional filler is granular and is dispersed in the second coating 2. In some embodiments, the average particle size of the second functional filler is D50₂, and the D50₂ is equal to or less than 3.5 μm. For example, when the second functional filler is composed of the above-mentioned second electrode active material and non-electrode active material, the second functional filler is a mixture of the second electrode active material and the non-electrode active material. D50₂ is a measured average particle size of the mixture.

According to this application, it is found that D50₁<D50₂<D50₃, and D50₃ is the average particle size of the first electrode active material in the active material layer 3. The content of the binder and the particle size of the functional particles (i.e. the second functional filler) in the second coating 2 are both between those of the first coating 1 and the active material layer 3, which can play a good transition role and increase a bonding force between the bi-functional layer (i.e. the first coating 1 and the second coating 2) and the active material layer 3, reduce the risks of powder falling off, partial peeling of coating, cracking of the electrode sheet, etc., and optimize the cycling performance, etc., of the electrode sheet.

In some embodiments, the second functional filler has a sphericity of P₂ and an average particle size of D50₂ expressed in μm, where it is possible to control P₂/D50₂≥0.2, preferably, P₂/D50₂≥0.25. The inventor's research found that controlling P₂/D50₂≥0.2 can further reduce the safety risks caused by needle puncture, heavy object impact, etc. Specifically, when the needle puncture or heavy object impact, etc. occurs, the nanoparticles in the second coating 2 can act as rolling friction, physically blocking the short-circuit mode between a needle or heavy object and the electrode sheet as well as the short-circuit mode between the positive and negative electrode sheets, reducing short-circuit points generated by cross-section burrs and sharp edges, thereby improving the safety and other properties of the electrode sheet and the electrochemical device. Preferably, P₂ is equal to or greater than 0.70, and the safety risks caused by needle puncture, heavy object impact, etc. can be further reduced.

Generally, a thickness of the first coating 1 is not greater than a thickness of the second coating 2. Preferably, the thickness of the first coating 1 is less than the thickness of the second coating 2, and the thickness of the second coating 2 is less than a thickness of the active material layer 3, which will facilitate to further improve the energy density and other properties of the electrode sheet. Specifically, the thickness of the first coating 1 may be 0.5 μm-5 μm, such as 0.5 μm, 1 μm, 2 μm, 3 μm, 4 μm, 5 μm, or a range composed of any two of them; the thickness of the second functional layer is 1.5 μm-8 μm, such as 1.5 μm, 2 μm, 3 μm, 4 μm, 5 μm, 6 μm, 7 μm, 8 μm or a range composed of any two of them; and the thickness of the active material layer 3 is 15 μm-80 μm, such as 15 μm, 20 μm, 30 μm, 40 μm, 50 μm, 60 μm, 70 μm, 80 μm or a range composed of any two of them.

In this application, unless otherwise specified, the thickness of the coating (such as the thickness of the first coating 1, the thickness of the second coating 2, and the thickness of the active material layer 3) refers to a thickness of a single-side coating, that is, the thickness of the coating located on one surface of the current collector 5, which does not include the thickness of the current collector 5 and is not a sum of the thickness of the coating on one surface of the current collector 5 and the thickness of the coating on the other surface of the current collector 5.

In this application, the above-mentioned electrode sheet may be a positive electrode sheet or a negative electrode sheet. When the electrode sheet is a positive electrode sheet, the above-mentioned current collector 5 is a positive current collector 5, for example, including at least one of an aluminum foil, a nickel foil and a first composite foil formed by compounding of a polymer layer and a first metal layer. The first metal layer may be an aluminum layer formed of aluminum and/or a nickel layer formed of nickel. The electrode active materials in the second coating 2 and the active material layer 3 (i.e., the first electrode active material and the second electrode active material) are positive active materials, which may specifically include a lithium-containing active material capable of extraction and insertion of lithium, for example include at least one of lithium cobalt oxide, lithium iron phosphate, lithium manganese phosphate, lithium iron manganese phosphate, lithium nickelate, lithium nickel cobalt manganate, lithium nickel cobalt aluminate, lithium vanadium phosphate, lithium-rich manganese material, lithium nickel iron aluminate, and lithium titanate. The lithium-rich manganese material (or lithium-rich manganese-based positive material) is generally composed of lithium manganate (Li₂MnO₃) and LiMO₂, where M includes at least one of Ni, Co, and Mn. When the electrode sheet is a negative electrode sheet, the above-mentioned current collector 5 is a negative current collector 5, for example, including at least one of a copper foil, a nickel foil, and a second composite foil formed by compounding of a polymer layer and a second metal layer. The second metal layer may be a copper layer formed of copper and/or a nickel layer formed of nickel. The electrode active materials in the second coating 2 and the active material layer 3 are negative active materials, for example, including at least one of artificial graphite, natural graphite, composite graphite, hard carbon, soft carbon, mesophase carbon microsphere, petroleum coke, oily needle coke, silicon, silicon oxide, silicon carbon, lithium titanate, and metallic lithium. The second electrode active material in the second coating 2 and the first electrode active material in the active material layer 3 may be the same or different.

Specifically, the first composite foil may be a sandwich-like structure formed by the polymer layer and the first metal layer, which generally includes two first metal layers and a polymer layer located between the two first metal layers (i.e. the two first metal layers are respectively located on the front and back surfaces of the polymer layer). The second composite foil may be a sandwich-like structure formed by the polymer layer and the second metal layer, which generally includes two second metal layers and a polymer layer located between the two second metal layers (that is, the two second metal layers are respectively located on the front and back surfaces of the polymer layer). During specific implementation, the above-mentioned metal layers (the first metal layer or the second metal layer) may be formed on the front and back surfaces of the polymer layer by evaporation, thermal compounding, etc., thereby obtaining the first composite foil or the second composite foil.

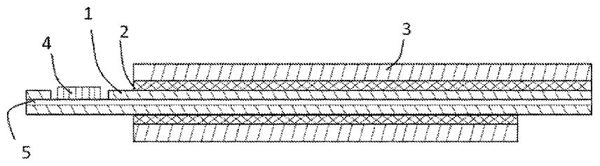

Generally, the electrode sheet is also provided with a tab 4, in particular, which may be welded to the current collector 5. In specific implementation, the current collector 5 may be provided with an uncoated foil zone without coating, where the tab 4 may be welded to the current collector 5. Furthermore, the functional coating may also be provided with a groove exposing the surface of the current collector 5, where the tab 4 is welded to the current collector 5. In some embodiments, as shown in FIG. 1, the first coating 1 includes a first region and a second region; and the second coating 2 and the active material layer 3 are sequentially stacked on the surface of the second region of the first coating 1. The first region of the first coating 1 is provided with the groove exposing the surface of the current collector 5, and the tab 4 is disposed in the groove. Specifically, the tab 4 can be welded to the current collector 5 at the bottom of the groove. However, the position of the tab 4 is not limited to this in this application.

The electrode sheet of this application may be produced by conventional methods in the art such as coating method. For example, the first coating 1, the second coating 2 and the active material layer 3 may be coated on the surface of the current collector 5 using the coating methods such as slit extrusion coating, blade transfer coating, gravure coating, slope flow coating, etc., which is not particularly limited. Generally, the first coating 1 and the second coating 2 are relatively thin and the gravure coating may be usually used, while the active material layer 3 may be prepared by the slit extrusion coating, which is not limited to this. After completing coating and then drying, the electrode sheet is then produced by roller pressing with a pressure of 50-100T, slitting according to the preset shape and size of the electrode sheet and other parameters, cleaning off the coating on the preset position of the tab 4, welding the tab 4 and other processes. During the coating process, the first coating 1 is relatively thin, and the coating at the preset position of the tab 4 may be cleaned off by laser cleaning or other methods, or the welding position for the tab 4 may be reserved by means of reserving the tab 4 with a gravure roller or other methods. The tab 4 is welded to the welding position for the tab 4 to obtain the electrode sheet.

In this application, the functional coating does not protrude from the outer edge of the current collector 5. That is, in an orthographic projection parallel to the surface of the current collector 5, the orthographic projection of the surface of the current collector 5 covers the orthographic projection of the functional coating. Usually, a surface area of the functional coating accounts for 40% to 100% of a surface area of the current collector 5. During specific implementation, the first coating 1 may be coated on the surface of the current collector 5 firstly, and the coating area accounts for 40% to 100% of the surface area of the current collector 5, so that the surface area of the formed first coating 1 accounts for 40% to 100% of the surface area of the current collector 5. Next, the second coating 2 and the active material layer 3 are sequentially coated on the surface of the first coating 1. The surface area of the first coating 1 is controlled to account for 40% to 100% of the surface area of the current collector 5, which is conducive to a higher contact area between the conductive agent in the first coating 1 and the current collector 5, reducing a surface resistance of the electrode sheet, and further optimizing the performance of the electrode sheet, such as the cycling performance.

In this application, the above-mentioned functional coating may be provided on only one surface of the current collector 5, or the above-mentioned functional coating may be provided on both the front and back surfaces of the current collector 5. Relatively speaking, the latter is more conducive to improving the performance of the electrode sheet, such as energy density, which may be selected as needed during specific implementation.

The electrochemical device of this application includes the above-mentioned electrode sheet. Specifically, the electrochemical device of this application may include a positive electrode sheet with the above-mentioned structural design (that is, the above-mentioned electrode sheet is the positive electrode sheet), or may include a negative electrode sheet with the above-mentioned structural design (that is, the above-mentioned electrode sheet is the negative electrode sheet), or may include both a positive electrode sheet with the above structural design and a negative electrode sheet with the above structural design (that is, the above electrode sheet includes both the positive electrode sheet and the negative electrode sheet). When the above-mentioned electrode sheet is a positive electrode sheet, the above-mentioned electrochemical device further includes a negative electrode sheet, which may be a conventional negative electrode sheet in this field. When the above-mentioned electrode sheet is a negative electrode sheet, the above-mentioned electrochemical device further includes a positive electrode sheet, which may also be a conventional positive electrode sheet in this field. This application is not particularly limited to these.

The above-mentioned electrochemical device also includes a separator (or a separating film) located between the positive electrode sheet and the negative electrode sheet. The separator is configured to separate the positive electrode sheet and the negative electrode sheet, and prevent short circuit caused by a contact between the positive electrode sheet and the negative electrode sheet. In a possible implementation, the separator includes a base film layer and a reinforcement layer located on at least one surface of the base film layer. Preferably, both front and back surfaces of the base film layer are each provided with a reinforcement layer. The reinforcement layer contains a binder and/or ceramic particles for providing electronic insulation, ensuring that lithium ions can pass through it, and providing certain mechanical properties. The reinforcement layer may be a coating formed by mixing the binder and ceramic particles, or the reinforcement layer includes an adhesive layer (or a bonding layer) located on the surface of the base film layer and a ceramic layer located on the surface of the adhesive layer. The adhesive layer includes a binder, and the ceramic layer includes ceramic particles. The base film layer may include a polymer, the polymer including at least one of polyethylene terephthalate, polybutylene terephthalate, polynaphthalenes polymer, polyethylene, polypropylene, polyacrylonitrile, polyimide, polyvinyl alcohol, aramid, polyparaphenylene benzobisoxazole, and aromatic polyamide. The binder may include at least one of polytetrafluoroethylene, polyurethane, polyvinylidene fluoride, polyimide, polyacrylonitrile, polymethylmethacrylate, styrene-butadiene rubber, lithium polystyrene sulfonate, epoxy resin, styrene-acrylic latex, polyacrylic acid, and polyethylene oxide. The ceramic particles may include at least one of alumina, magnesium oxide, boehmite, magnesium hydroxide, barium sulfate, barium titanate, zirconium oxide, magnesium aluminate, silicon oxide, hydrotalcite, tourmaline, zinc oxide, calcium oxide, and fast-ion nano particles.

The above-mentioned electrochemical device further includes an electrolyte. For example, the electrolyte used may include a non-aqueous electrolyte, whose components may include a non-aqueous solvent and a lithium salt. The non-aqueous solvent includes at least one of carbonates, carboxylates, sulfonates and ether compounds. The lithium salt includes at least one of lithium hexafluorophosphate (LiPF₆), lithium tetrafluoroborate (LiBF₄), lithium bisoxalate borate (LiBOB), and lithium bisfluorosulfonimide (LiFSi). In addition, the electrolyte may further include an additive, such as overcharging additive and/or film-forming additive, which may be conventional electrolyte additive in this field.

The electrochemical device of this application may be a battery, especially a lithium-ion battery, which may be a winding lithium-ion battery or a stacked lithium-ion battery with a single electrode sheet, etc., and which may be a common form in the field, such as a pouch, a square shell, a steel shell, a cylinder, a button, etc.

The battery of this application may be produced according to a conventional method in this field. For example, the positive electrode sheet, separator, and negative electrode sheet may be stacked in sequence, winded (or stacked) to form a battery cell, followed by sealing, inkjet coding, electrolyte injecting, standing, formation, re-sealing, sorting, OCV (testing open circuit voltage), etc., to obtain the battery. These steps/processes are all routine operations in this field, which are not particularly limited in this application and will not be repeated again.

In order to make the purposes, technical solutions and advantages of this application clearer, the technical solutions of this application will be clearly and completely described below in conjunction with specific examples. Obviously, the described examples are part of, not all of the examples of this application. Based on the examples of this application, all other examples obtained by those skilled in the art without creative efforts fall within the protection scope of this application.

### Example 1

### 1. Preparation of the Positive Electrode Sheet

Carbon black, polyacrylic acid, and polytetrafluoroethylene particles were added into a planetary mixer in sequence, where water was added as a solvent for uniform dispersion, thus obtaining a first slurry. The carbon black, the polyacrylic acid, and the polytetrafluoroethylene particles had a mass ratio of 20:50:30.

The first slurry was coated on the front and back surfaces of an aluminum foil at a coating speed of 50 m/min using a 150-mesh gravure coater. After completing coating, the coated aluminum foil was placed in an oven for drying at 95° C. to form a first coating on the surfaces of the aluminum foil.

Lithium iron phosphate, barium sulfate, carbon black, carbon tube, and PVDF were added into the planetary mixer in sequence, where N-methylpyrrolidone (NMP) was added as a solvent for uniform dispersion, thus obtaining a second slurry. The lithium iron phosphate, the barium sulfate, the carbon black, the carbon tube, and the PVDF had a mass ratio of 70:22:2:1:5.

Then, the second slurry was coated on the surfaces of the first coatings on the front and back surfaces of the aluminum foil at a coating speed of 35 m/min using a 110-mesh gravure coater. After completing coating, the coated aluminum foil was placed in an oven for drying at 105° C. to form a second coating on the surface of the first coating.

Lithium cobalt oxide, carbon black and PVDF were added to N-methylpyrrolidone (NMP) according to a mass ratio of 96:1.5:2.5, followed by uniform dispersion to form a positive electrode slurry. The positive electrode slurry was coated on the surfaces of the second coatings on the front and back surfaces of the aluminum foil at a coating speed of 20 m/s using a slit extrusion coater. After completing coating, the coated aluminum foil was placed in an oven and dried at 110° C. to form a positive active material layer on the surface of the second coating. Then, the positive electrode sheet (its structure is shown in FIG. 1) was obtained by one-time rolling with a pressure of 75T,? cutting, cleaning off the coating at the preset position for the tab, welding the tab, etc.

The aluminum foil has a thickness of 10 μm. The first coating formed on each surface of the aluminum foil has a surface area which basically accounts for 100% of the aluminum foil (that is, 100% area is coated). The first coating has a thickness of 1.2 μm, the second coating has a thickness of 5 μm, and the active material layer has a thickness of 55 μm. The average particle size D50₁ of the first functional filler (the polytetrafluoroethylene particles) is 0.7 μm, and the average particle size D50₂ of the second functional filler (a mixture of the lithium iron phosphate and the barium sulfate) is 0.9 μm. The second functional filler (a mixture of the lithium iron phosphate and the barium sulfate) has a sphericity P₂ of 0.8. The average particle size D503 of the active material (the lithium cobalt oxide) in the positive active material layer is 8.5 μm. The average particle size D50₄ of the conductive agent (the carbon black) in the first coating is 0.08 μm.

### 2. Preparation of the Negative Electrode Sheet

Artificial graphite, styrene-butadiene rubber, sodium carboxymethyl cellulose, and carbon black were added into a planetary mixer according to a mass ratio of 96:2.5:0.5:1, where water was added as a solvent and mixed uniformly to obtain a negative electrode slurry. Then, the negative electrode slurry was coated on the front and back surfaces of the copper foil (with a thickness of 6 μm) using a slot extrusion coater. After completing coating, the coated aluminum foil was placed in an oven and dried at 95° C. to form negative active material layers on the surfaces of the copper foil. The negative electrode sheet was obtained by processes including rolling with a rolling pressure of 30T, cutting, and welding the tab.

### 3. Preparation of the Battery

After the positive electrode sheet, the separator, and the negative electrode sheet were stacked in sequence, they are winded to form an electrical core (or a roll core). The electrical core was hot-pressed at 50° C. under 0.5 MPa and then subjected to a Hi-pot testing, followed by the processes such as sealing, inkjet coding, electrolyte injection, standing, formation, re-sealing, sorting, and OCV testing, obtaining a lithium ion battery. Where, the separator included a base film layer, adhesive layers located on the front and back surfaces of the base film layer, and ceramic layers located on the surfaces of the adhesive layers which are located on the front and back surfaces of the base film layer. The base film layer had a thickness of 7 μm, and the adhesive layer had a thickness of 2 μm, and the ceramic layer had a thickness of 2 μm. The ceramic particles were boehmite.

### Example 2-Example 10

The difference between Example 2 and Example 1 lies in that the thickness of the first coating is 0.7 μm in Example 2, with the other conditions being basically the same as Example 1.

The difference between Example 3 and Example 1 lies in that the thickness of the first coating is 1.8 μm in Example 3, with the other conditions being basically the same as Example 1.

The difference between Example 4 and Example 1 lies in that the alumina is used to replace the barium sulfate in Example 4, with the other conditions being basically the same as Example 1.

The difference between Example 5 and Example 1 lies in that the mass ratio of the carbon black, the polyacrylic acid, and the polytetrafluoroethylene particles is 40:30:30 in Example 5, with the other conditions being basically the same as Example 1.

The difference between Example 6 and Example 1 lies in that the mass ratio of the carbon black, the polyacrylic acid, and the polytetrafluoroethylene particles is 10:60:30 in Example 6, with the other conditions being basically the same as Example 1.

The difference between Example 7 and Example 1 lies in that the mass ratio of the carbon black, the polyacrylic acid, and the polytetrafluoroethylene particles is 10:50:40 in Example 7, with the other conditions being basically the same as Example 1.

The difference between Example 8 and Example 1 lies in that the mass ratio of the lithium iron phosphate, the barium sulfate, the carbon black, the carbon tube, and the PVDF in the second slurry is 65:22:2:1:10 in Example 8, with the other conditions being basically the same as Example 1.

The difference between Example 9 and Example 1 lies in that the mass ratio of the lithium cobalt oxide, the carbon black and the PVDF in the positive electrode slurry is 94.5:1.5:4 in Example 9, with the other conditions being basically the same as Example 1. The difference between Example 10 and Example 1 lies in that D50₁=0.4 μm in Example 10, with the other conditions being basically the same as Example 1.

### Comparative Example 1-Comparative Example 7

The difference between Comparative Example 1 and Example 1 lies in there is no first coating and second coating in Comparative Example 1, that is, there is only the active material layer and the thickness of the active material layer is same as that of Example 1. The remaining structural design and preparation process are also basically same as those in Example 1.

The difference between Comparative Example 2 and Example 1 lies in there is no first coating in Comparative Example 2. The second coating and the active material layer in Comparative Example 2 are the same as those in Example 1, and the remaining structural design and preparation process are also basically same as Example 1.

The difference between Comparative Example 3 and Example 1 lies in there is no second coating in Comparative Example 3. The first coating and the active material layer in Comparative Example 3 are the same as those in Example 1, and the remaining structural design and preparation process are also basically same as Example 1.

The difference between Comparative Example 4 and Example 1 lies in that the mass ratio of the carbon black, the polyacrylic acid, and the polytetrafluoroethylene particles is 20:4:76 in Comparative Example 4, with the other conditions being basically the same as Example 1.

The difference between Comparative Example 5 and Example 1 lies in that the mass ratio of the lithium iron phosphate, the barium sulfate, the carbon black, the carbon tube, and the PVDF in the second slurry is 25:22:2:1:50 in Comparative Example 5, with the other conditions being basically the same as Example 1.

The difference between Comparative Example 6 and Example 1 lies in that the mass ratio of the lithium cobalt oxide, the carbon black and the PVDF in the positive electrode slurry is 93:1.5:5.5 in Comparative Example 6, with the other conditions being basically the same as Example 1.

The difference between Comparative Example 7 and Example 1 lies in that D50₁=3.0μm in Comparative Example 7, with the other conditions being basically the same as Example 1.

Performance tests were performed on the batteries of each example and comparative example. The results are shown in Table 1, and the test processes are briefly described as follows.

(1) Needle puncture test: puncturing the geometric center of the electric core at a speed of 50 mm/s using a tungsten steel needle with a diameter of 3.0 mm, a length of 100 mm and a tip cone angle of 45°, and penetrating the electric core for 30 minutes. If there is no smoke, fire or explosion, the battery is considered as being qualified. There are 10 batteries in each group for testing. The needle puncture qualification rate=N1/10, where N1 is the number of the qualified battery.

(2) Overcharging test: charging the battery to 5V at a constant current of 3 C, and maintaining for 1 hour after reaching 5V. If there is no smoke, fire or explosion, the battery is considered as being qualified. There are 10 batteries in each group for testing. Overcharging qualification rate=N2/10, where N2 is the number of the qualified battery.

(3) Heavy object impact test: placing the electric core on a plane, placing a crossbar with a diameter of 15.8 mm in the middle of the electric core, and allowing a heavy object with a weight of 9.1 kg to fall off freely from a height of 630 mm away from the electric core to impact the battery cell. If there is no smoke, fire or explosion, the battery is considered as being qualified. There are 10 batteries in each group for testing. Qualification rate of heavy object impact=N3/10, where N3 is the number of the qualified battery.

(4) Cycling performance test: charging the battery to a cut-off voltage at 0.7 C, discharging it to 3.0V at 0.5 C after reaching the cut-off voltage of 0.025 C, and performing a cycle charge and discharge test in this mode. There are 5 batteries in each group for testing, and the average value of the test results of the 5 batteries is sampled, obtaining the capacity retention rate of battery after 500 cycles (500T) (the capacity retention rate=the capacity of battery after 500T cycling/the initial capacity of battery before cycling).

(5) Sphericity measurement: the sphericity of particles is calculated using a machine vision technology, where the area and perimeter of 100 specific types of particles in a specified area are automatically recognized and measured, followed by being introduced into the following formula to calculate the sphericity of a single particle. A median of these 100 sphericities is considered as the sphericity Q of this type of filler,

$$Q = \frac{4 π S}{{L}^{2}}$$

where S is an area of a cross-section of the particle, expressed in μm², and L is a perimeter of the cross-section of the particle, expressed in μm.

TABLE 1

| | | Mass ratio of | | | | |
|---|---|---|---|---|---|---|
| | | carbon black, | | | | |
| | | polyacrylic | | | | |
| | Thickness | acid, | Qualification | Qualification | Qualification | Capacity |
| | of the | and polytetra- | rate of | rate of | rate of | retention |
| | first | fluoroethylene | needle | overcharging | heavy object | rate after |
| Example | coating | particles | puncture test | test | impact | 500T cycles |
| Example 1 | 1.2 μm | 20:50:30 | 10/10 | 10/10 | 10/10 | 94.3% |
| Example 2 | 0.7 μm | 20:50:30 | 10/10 | 7/10 | 10/10 | 94.5% |
| Example 3 | 1.8 μm | 20:50:30 | 10/10 | 10/10 | 10/10 | 94.1% |
| Example 4 | 1.2 μm | 20:50:30 | 10/10 | 10/10 | 10/10 | 94.0% |
| Example 5 | 1.2 μm | 40:30:30 | 10/10 | 9/10 | 10/10 | 94.7% |
| Example 6 | 1.2 μm | 10:60:30 | 10/10 | 10/10 | 10/10 | 93.8% |
| Example 7 | 1.2 μm | 10:50:40 | 10/10 | 10/10 | 10/10 | 94.2% |
| Example 8 | 1.2 μm | 20:50:30 | 10/10 | 10/10 | 10/10 | 93.6% |
| Example 9 | 1.2 μm | 20:50:30 | 10/10 | 10/10 | 10/10 | 93.4% |
| Example 10 | 1.2 μm | 20:50:30 | 10/10 | 10/10 | 10/10 | 94.4% |
| Comparative | / | / | 0/10 | 2/10 | 0/10 | 93.2% |
| Example 1 | | | | | | |
| Comparative | / | / | 8/10 | 3/10 | 7/10 | 93.7% |
| Example 2 | | | | | | |
| Comparative | 1.2 μm | 20:50:30 | 2/10 | 8/10 | 4/10 | 94.1% |
| Example 3 | | | | | | |
| Comparative | 1.2 μm | 20:4:76 | 6/10 | 5/10 | 3/10 | 93.0% |
| Example 4 | | | | | | |
| Comparative | 1.2 μm | 20:50:30 | 2/10 | 10/10 | 10/10 | 91.9% |
| Example 5 | | | | | | |
| Comparative | 1.2 μm | 20:50:30 | 10/10 | 10/10 | 10/10 | 92.2% |
| Example 6 | | | | | | |
| Comparative | 3.5 μm | 20:50:30 | 3/10 | 6/10 | 4/10 | 92.8% |
| Example 7 | | | | | | |

As can be seen from Table 1, the positive electrode sheet of Comparative Example 1 includes no first coating and second coating and includes only the active material layer, and cannot be qualified by the needle puncture test and heavy object impact test, and its qualification rate of the overcharging test is also very low. In addition, after the 500T cycle, the batteries are dissected and it has been found that there is a clear demoulding of the positive electrode and a low capacity retention rate. The positive electrode sheet of Comparative Example 2 does not include the first coating, and the qualification rates of needle puncture and heavy object impact are each reduced, especially the qualification rate of overcharging test is reduced with a larger extent. The positive electrode sheet of Comparative Example 3 does not include the second coating, and the qualification rates of needle puncture test and heavy object impact test are also reduced, and meanwhile the qualification rate of overcharging test is also reduced relative to that of the Examples. It is indicated from Examples 7 to 9 that when a1>a2>a3 is satisfied, the safety and cycling performances of the batteries will meet requirements simultaneously. However, it is indicated from Comparative Examples 4 to 6 that if a1>a2>a3 is not satisfied, the safety and cycling performances may be damaged. Furthermore, it is indicated from Examples 10 that smaller value of D50₁ of particles may meet requirements of the safety performance of the battery. However, it is indicated from Comparative Example 7 that when the value of D50₁ is higher and D50₁<D50₂<D50₃ is not satisfied, the safety and cycling performances of the battery will be reduced significantly. Therefore, compared with Comparative Examples 1 to 7, the batteries of Examples 1 to 10 have higher qualification rates of needle puncture and heavy object impact and also have higher overcharging qualification rate, showing good safety, good capacity retention rate and good cycling performance and other properties. It is indicated that introducing the first coating and the second coating (bi-functional layer) into the positive electrode sheet reduces the probability of the positive active material layer peeling off to expose the aluminum foil, avoids the short circuit caused by the contact between the aluminum foil and the negative electrode sheet, increases the safety when being needle punctured and impacted by heavy objects. Meanwhile, the overcharge performance of the positive electrode is improved, especially to meet the qualification rate for batteries under 3 C-5V conditions, and the impedance of the positive electrode sheet is reduced, thus improving the safety and the cycling performance of the battery simultaneously.

The embodiments of this application have been described above. However, this application is not limited to the above-mentioned embodiments. Any amendments, equivalent substitutions, improvements, etc. made within the spirit and principles of this application shall be included in the protection scope of this application.

What is claimed is:

1. An electrode sheet, comprising a current collector and a functional coating provided on at least one surface of the current collector; wherein the functional coating comprises a first coating provided on a surface of the current collector, a second coating provided on a surface of the first coating and an active material layer provided on a surface of the second coating;
the first coating comprises a conductive agent, a binder and a first functional filler;
the second coating comprises a conductive agent, a binder and a second functional filler;
the active material layer comprises a conductive agent, a binder and a first electrode active material;
a mass ratio of the binder in the first coating to the first coating is al, a mass ratio of the binder in the second coating to the second coating is a2, and a mass ratio of the binder in the active material layer to the active material layer is a3; a1>a2>a3.

2. The electrode sheet according to claim 1, wherein
the first functional filler comprises an inorganic filler and/or a polymer filler; the inorganic filler comprises at least one of alumina, silica, silicon monooxide, titanium oxide, zinc oxide, zirconium oxide, cerium oxide, vanadium pentoxide, ferrous oxide, boehmite, hydrotalcite, and metal salt; the polymer filler comprises at least one of polytetrafluoroethylene particles, polyethylene microspheres, polystyrene microspheres, and polyurethane microspheres; and/or
an average particle size of the first functional filler is D50₁, an average particle size of the second functional filler is D50₂, and an average particle size of the first electrode active material in the active material layer is D50₃, which satisfies D50₁<D50₂<D50₃; and/or, D50₁≤2.5 μm; and/or, D50₂≤3.5 μm; and/or, D50₃<5 μm.

3. The electrode sheet according to claim 1, wherein an average particle size of the conductive agent in the first coating is D50₄, and D50₄≤0.8 μm.

4. The electrode sheet according to claim 2, wherein an average particle size of the conductive agent in the first coating is D50₄, and D50₄≤0.8 μm.

5. The electrode sheet according to claim 1, wherein
the second functional filler comprises a second electrode active material and a non-electrode active material; in the second coating, the second electrode active material has a mass content of 0-98.5%, the non-electrode active material has a mass content of 0-98.5%;
and the mass content of the second electrode active material and the mass content of the non-electrode active material are not both 0 at the same time; and/or
the second functional filler has a sphericity of P₂, and an average particle size of the second functional filler is D50₂ expressed in μm, which satisfies: P₂/D50₂≥0.2, and/or, P₂≥0.70.

6. The electrode sheet according to claim 5, wherein
a mass ratio of the first electrode active material in the active material layer to the active material layer is not less than a mass ratio of the second electrode active material in the second coating to the second coating; and/or
the first electrode active material is same as or different from the second electrode active material; and/or
the non-electrode active material comprises an inorganic filler and/or a polymer filler, and the inorganic filler comprises at least one of alumina, silica, silicon monooxide, titanium oxide, zinc oxide, zirconium oxide, cerium oxide, vanadium pentoxide, oxide iron, boehmite, hydrotalcite, and metal salt; the metal salt comprises barium sulfate and/or calcium sulfate;
the polymer filler comprises at least one of polytetrafluoroethylene particles, polyethylene microspheres, polystyrene microspheres and polyurethane microspheres; and/or
in the second coating, neither the mass content of the second electrode active material nor the mass content of the non-electrode active material is 0.

7. The electrode sheet according to claim 1, wherein
the first coating further comprises a dispersant, the dispersant comprising at least one of sodium carboxymethylcellulose, lithium carboxymethylcellulose, sodium polyacrylate, and polyvinylpyrrolidone; in the first coating, the conductive agent has a mass content of 2%-45%, the binder has a mass content of 5%-70%, the first functional filler has a mass content of 0-70%, and the dispersant has a mass content of 0-10%; and/or
in the second coating, the conductive agent has a mass content of 0.5%-10%, the binder has a mass content of 3%-30%, and a balance of the second coating is the second functional filler; and/or
in the active material layer, the conductive agent has a mass content of 0.5%-5%, the binder has a mass content of 1%-5%, and the first electrode active material has a mass content of 90%-98.5%.

8. The electrode sheet according to claim 6, wherein
the first coating further comprises a dispersant, the dispersant comprising at least one of sodium carboxymethylcellulose, lithium carboxymethylcellulose, sodium polyacrylate, and polyvinylpyrrolidone; in the first coating, the conductive agent has a mass content of 2%-45%, the binder has a mass content of 5%-70%, the first functional filler has a mass content of 0-70%, and the dispersant has a mass content of 0-10%; and/or
in the second coating, the conductive agent has a mass content of 0.5%-10%, the binder has a mass content of 3%-30%, and a balance of the second coating is the second functional filler; and/or
in the active material layer, the conductive agent has a mass content of 0.5%-5%, the binder has a mass content of 1%-5%, and the first electrode active material has a mass content of 90%-98.5%.

9. The electrode sheet according to claim 1, wherein
a thickness of the first coating is not more than a thickness of the second coating, and the thickness of the second coating is less than a thickness of the active material layer; and/or
the thickness of the first coating is 0.5 μm-5 μm; and/or
the thickness of the second coating is between 1.5 μm and 8 μm; and/or
the thickness of the active material layer is 15 μm - 80 μm.

10. The electrode sheet according to claim 1, wherein
the electrode sheet is a positive electrode sheet, the first electrode active material comprising at least one of lithium cobalt oxide, lithium iron phosphate, lithium manganese phosphate, lithium iron manganese phosphate, lithium nickelate, lithium nickel cobalt manganate, lithium nickel cobalt aluminate, lithium vanadium phosphate, lithium-rich manganese material, lithium nickel iron aluminate and lithium titanate; or
the electrode sheet is a negative electrode sheet, the first electrode active material comprising at least one of artificial graphite, natural graphite, composite graphite, hard carbon, soft carbon, mesocarbon microsphere, petroleum coke, oily needle coke, silicon, silicon oxide, silicon carbon, lithium titanate, and metallic lithium.

11. The electrode sheet according to claim 5, wherein
the electrode sheet is a positive electrode sheet, the second electrode active material comprising at least one of lithium cobalt oxide, lithium iron phosphate, lithium manganese phosphate, lithium iron manganese phosphate, lithium nickelate, lithium nickel cobalt manganate, lithium nickel cobalt aluminate, lithium vanadium phosphate, lithium-rich manganese material, lithium nickel iron aluminate and lithium titanate; or
the electrode sheet is a negative electrode sheet, the second electrode active material comprising at least one of artificial graphite, natural graphite, composite graphite, hard carbon, soft carbon, mesocarbon microsphere, petroleum coke, oily needle coke, silicon, silicon oxide, silicon carbon, lithium titanate, and metallic lithium.

12. The electrode sheet according to claim 6, wherein
the electrode sheet is a positive electrode sheet, the second electrode active material comprising at least one of lithium cobalt oxide, lithium iron phosphate, lithium manganese phosphate, lithium iron manganese phosphate, lithium nickelate, lithium nickel cobalt manganate, lithium nickel cobalt aluminate, lithium vanadium phosphate, lithium-rich manganese material, lithium nickel iron aluminate and lithium titanate; or
the electrode sheet is a negative electrode sheet, the second electrode active material comprising at least one of artificial graphite, natural graphite, composite graphite, hard carbon, soft carbon, mesocarbon microsphere, petroleum coke, oily needle coke, silicon, silicon oxide, silicon carbon, lithium titanate, and metallic lithium.

13. An electrochemical device, comprising the electrode sheet according to claim 1.
